(19) United States
(12) Patent Application Publication
(10) Pub. No.: US 2002/0019738 A1
(43) Pub. Date: Feb. 14, 2002

(54) Recruitment information providing system

(76) Inventor: Gaku Yamamoto, Tokyo (JP)

Correspondence Address: BIRCH STEWART KOLASCH & BIRCH, PO BOX 747, FALLS CHURCH, VA, 22040-0747, US

(21) Appl. No.: 09/757,605

(22) Filed: Jan. 11, 2001

(30) Foreign Application Priority Data
Aug. 10, 2000 (JP) 2000-243197

(51) Int. Cl. G06F 17/60

(52) U.S. Cl. 705/1

(57) ABSTRACT

The present invention is intended to provide a recruitment information providing system wherein a recruiter providing recruitment information may pay more reasonable equivalent for provision of recruitment information by introducing a reward for success system, and a manager may obtain a reward more precisely, and an applicant may receive an advantage such as an encouraging bonus. A recruiting system comprising a means 300 to provide a number of persons with recruitment information, a means 400 to receive a report about a specific relation settled between an applicant who came in contact with recruitment information and a recruiter from at least either one of the applicant and recruiter, a means 500 to produce information to make a request for an information providing fee to a recruiter in accordance with the information received from at least one of the applicant and recruiter, and a means 600 to produce information to grant an advantage to the relevant applicant in accordance with the information received from at least either one of the applicant and recruiter.

### BACKGROUND OF THE INVENTION

The present invention relates to a recruitment information providing system for various kinds of information such as help wanted information, member recruiting information, and student recruiting information.

Conventionally, there have been various means adopted to provide recruitment information, especially help wanted information, member recruiting information and student recruiting information, but basically the following method is available.

For example, in the case of help wanted information, recruitment information appears in media (newspaper, magazine, bulletin board, web site on Internet, etc.) managed by a manager. The applicant finding the recruitment information takes an action to the recruiter by sending an application for interview, personal history or the like, and after that, interviews, tests, etc. are executed between the recruiter and the applicant, and the employment is decided through an agreement between the two sides. The above-mentioned advertisement of help wanted information is made by the recruiter at manager's request, and when there is a charge, the price is set in accordance with the size and frequency of the advertisement. In any case, the recruiter pays the charge (for advertisement) to the manager as the equivalent of the advertisement, and it is necessary for the recruiter to pay the charge irrespective of whether the recruitment was successful or not.

However, the recruiter really wants to find a job applicant suited for the contents of recruitment and to employ a capable person. Consequently, the equivalent (charge for advertisement) paid by the recruiter and the result (new staff employed) do not balance in many cases.

Thus, the equivalent paid and the result obtained by the recruiter do not usually balance in a conventional method of providing recruitment information.

As described above, in a conventional method of providing recruitment information, the equivalent paid and the result obtained by the recruiter do not balance. In order to improve the present condition, it is necessary to introduce a reward for success system, that is, a price system in which the recruiter pays the equivalent to the manager in accordance with the result obtained by the recruiter.

Such reward for success system can be said to be desirable for recruiters but extremely inconvenient and unreliable for managers. That is, to obtain the reward in accordance with the reward for success system, it is necessary for the manager to obtain the information about decision on employment from the recruiter. Naturally, a contract is to be concluded between the manger and the recruiter before making the advertisement of recruitment information, but it is actually difficult for the manger to check for the decision made by the recruiter, taking much time and labor to confirm the decision even when it is possible. Accordingly, such reward for success system completely depends upon the report from the recruiter and there is no practical way to check whether the recruiter makes a correct report or not, and even when an incorrect report was made by a recruiter, it would be impossible to confirm the fact in the reward system. It can be said that the reward for success system is very unreliable. Particularly, in the case of a transaction through a computer network, the relation between the manager and the recruiter may become less intimate to each other and it can be predicted that many of those concerned will feel uneasy about the reward for success system.

Further, there has been no recruitment information system in which some advantage such as a bounty or the like is given from the manager to the applicant at the time of decision on employment.

Accordingly, the present invention is intended to provide a recruitment information providing system that is advantageous to all the three of a recruiter, a manager and an applicant. More particularly, the recruiter fully or partially employs a reward payment system (reward for success system) in accordance with actual result such as decision on employment and is able to pay more reasonable charge for the provision of recruitment information, while the manager is able to obtain the reward even when the reward for success system is fully or partially introduced, and the applicant is able to obtain an advantage such as an encouraging bonus by satisfying certain conditions such as decision on employment.

### BRIEF SUMMARY OF THE INVENTION

A first embodiment of the present invention provides a recruiting system comprising a recruitment information providing means to provide recruitment information to a number of persons, a means to receive a report about a specific relation settled between an applicant who came in contact with the recruitment information and a recruiter from at least either one of the applicant and the recruiter, a means to produce information to make a request for payment of an information providing fee to the recruiter in accordance with the information received from at least either one of the applicant and the recruiter, and a means to produce information to give an advantage to the relevant applicant in accordance with the information received from at least either one of the applicant and the recruiter.

A second embodiment of the present invention provides a recruiting system comprising a recruitment information providing means to provide recruitment information about employment and information about an encouraging bonus given to the applicant at the time of decision on employment through a computer network, a means to receive a report about recruiter's decision on employment of the applicant who came in contact with recruitment information provided by the information providing means from at least either one of the applicant to be employed and the recruiter, a means to memorize the received information about decision on employment, a means to produce information to make a request for payment of an information providing fee to the recruiter in accordance with the memorized information about decision on employment, and a means to produce information to give an advantage at the time of decision on employment to the person who delivered the report of employment in accordance with the memorized information about decision on employment.

A third embodiment of the present invention provides a recruiting method comprising a step to collect recruitment information by informing about an application for reward at a stage when a specific relation has been settled between an applicant who came in contact with the recruitment information and a recruiter, a step to receive a report about a specific relation settled between the applicant who came in contact with the recruitment information and the recruiter from at least either one of the applicant and the recruiter, a step to make a request for payment of reward to the recruiter in accordance with the information received from at least either one of the applicant and the recruiter, and a step to give an advantage to the relevant applicant after receiving the reward, in a recruitment information providing method to provide recruitment information through a computer network.

In the present invention, since an applicant gives a manager a report about a specific relation settled between the applicant and the recruiter for which the applicant is to work for a certain period of time for example, the applicant is granted an advantage. Accordingly, the applicant will positively utilize the recruitment information system in order to receive such advantage and make a report about the matter. The manager, receiving the report from the applicant, is able to precisely find that a specific result such as achieving a recruiting purpose has been obtained and to precisely make a request for payment of the reward for success to the recruiter. The recruiter, employing the reward payment system (reward for success system) fully or partially in accordance with the actual result such as decision on employment, is able to pay more reasonable charge for the provision of recruitment information. Preferably, a recruiter gives a manager a report about a specific relation settled between the applicant and the recruiter for which the applicant is to work for a certain period of time for example, and even in that case, if the recruiter does not make a report to the manager and consequently the applicant is not granted an advantage, the applicant will make an inquiry to the manager or the recruiter so that the manager is able to confirm that the provision of recruitment information has brought about a specific result such as achieving a recruiting purpose.

### BRIEF DESCRIPTION Of THE DRAWINGS

FIG. 1 is an outline diagram of a recruitment information providing system as defined in en embodiment of the present invention.

FIG. 2 is a process explanatory diagram of a recruitment information providing method using the recruitment information providing system.

FIG. 3 is an outline diagram of a home page opened by the recruitment information providing system.

FIG. 4 is an explanatory diagram of an input screen for specific recruitment information of the recruitment information providing system.

FIG. 5 is an explanatory diagram of a screen for reading of a recruitment information database of the recruitment information providing system.

FIG. 6 is an explanatory diagram of a screen to make an application for an advantage in the recruitment information providing system.

FIG. 7 is an explanatory diagram of an electronic mail format for application confirmation in the recruitment information providing system.

### DETAILED DESCRIPTION OF THE PREFERRED EMBODIMENTS

### Outline

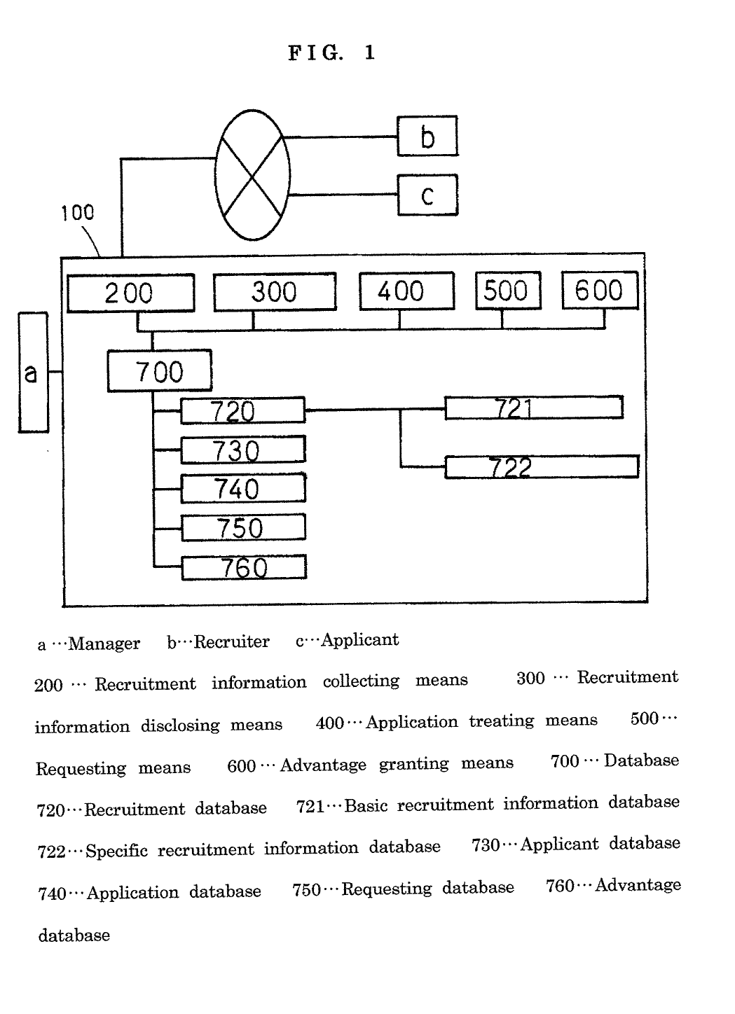

FIG. 1 shows an outline of a recruitment information providing system 100, and the system 100 comprises a recruitment information collecting means 200, recruitment information disclosing means 300, an application treating means 400, a requesting means 500, and an advantage granting means 600. The recruitment information providing system 100 is constructed so as to utilize hardware resources such as computers placed under the management of a manager a. The hardware resources such as computers comprise a memory means (preferably data base 700) which stores necessary information and are connected to the terminal equipment of applicant c and recruiter b through information network such as Internet by an information providing server (not shown) such as a WWW server. The terminal equipment of applicant c and recruiter b includes portable terminals such as portable telephones as well as computers. The information providing server comprises hardware resources such as computers which are same as and/or different from the computers of the recruitment information providing system 100, and produces information such as screen information of HTML type and distributes the information to the terminal equipment in the form of WWW of Internet. To achieve the purpose, it is possible to employ a distributing means using a computer network to which equipment comprising various data communication functions such as personal computer communication, electronic mail, portable telephones and game machines can be connected. Also, the returned information with the necessary information entered in the screen information can be received by the terminal equipment. The information providing server functions not only as a WWW server but also as an electronic mail server, and is able to transmit an electronic mail to applicant c and recruiter b as needed. Incidentally, the description in the following mainly refers to each means such as recruitment information providing means 200, and the information providing server will not be described except when necessary since it is a communication means being attendant on each means.

Recruitment information collecting means 200 is a means to collect recruiting information that can be obtained from recruiters (enterprises such as firms, organizations, etc. recruiting new employees) (hereinafter it is also called recruitment information).

Recruitment information disclosing means 300 is a means to provide recruitment information to unspecific and/or specific persons (mainly individuals such as job applicants).

Application treating means 400 is a means to receive a report from the applicant such that a specific relation (for example, decision on employment) has been settled between the applicant and the recruiter.

Requesting means 500 is a means to produce information to make a request for payment of an information providing fee to the recruiter in accordance with the information received from the applicant.

Advantage granting means 600 is a means to produce information to give an advantage to the relevant applicant in accordance with the information received from the applicant.

Data base 700 includes recruiting data base 720, applicant data base 730, application data base 740, requesting data base 750 and advantage data base 760. It is desirable to keep the necessary information in the form of a database as described, but all the information is not always required to be kept in a database, and it is also preferable to store the information in a memory means as only information that is not kept in a database.

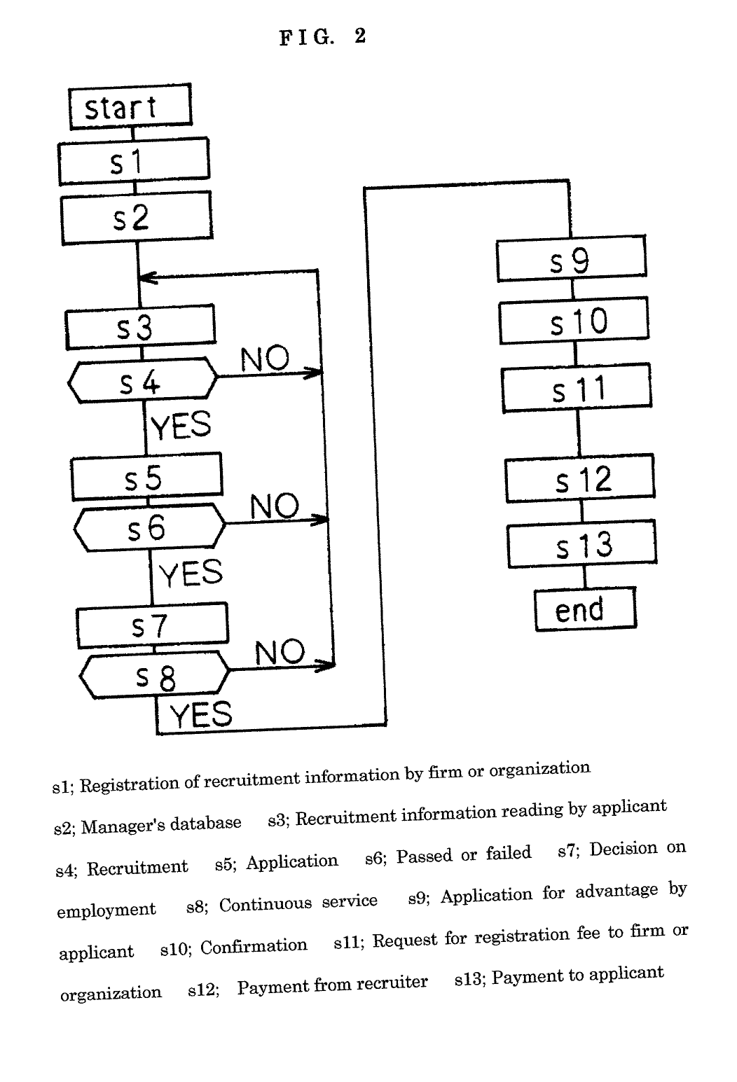

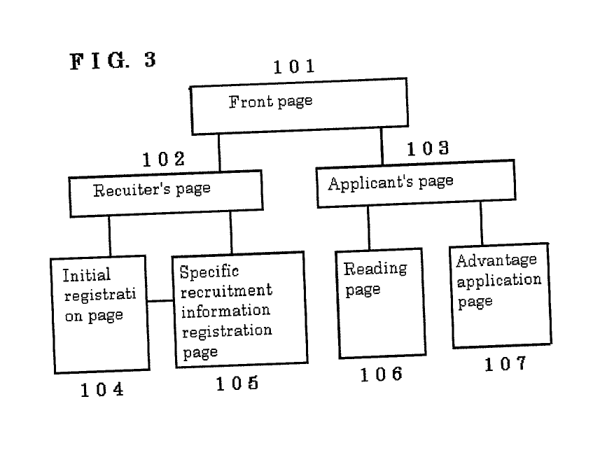

FIG. 2 is an explanatory diagram of processes for a recruitment information providing method using a recruitment information providing system related to the present embodiment, and FIG. 3 is a schematic diagram of a home page disclosed by the recruitment information providing system. The method will be described in the following with reference to the drawing.

Registration of Recruit Information by Firm or Organization; s 1

Recruiter b such as a firm and organization desiring to do recruitment by this system makes the registration of recruit information by Internet or off-line system in a written form. That is, manager a collects recruitment information by using the recruitment information providing means 200.

The recruit information registered can be roughly divided into basic information of recruiter b and specific recruitment information. As for these two kinds of information, it is possible to register all the information every application for specific recruitment, but in the present example, it is preferred to first register the basic information of recruiter b, and it is not required to register the basic information at the time of registering the specific recruitment information.

Registration of Basic Information by Recruiter

Recruiter b first connects the terminal equipment to Internet and sends URL of an information providing server to make the connection with the web site of manager a. The recruitment information collecting means 200 of manager a sends “Front page 101” (front page screen) to the terminal equipment of recruiter b. The page is linked to “Recruiter's page 102” and “Applicant's page 103,” and the recruiter b clicks the button of “Recruiter's page 102” to advance to “Initial registration page 104.” When the recruiter b has advanced to “Initial registration page 104,” the recruitment information collecting means 200 transmits the screen information for initial registration of recruiter b to the terminal equipment of recruiter b. The “Initial registration page 104” is provided with information to explain about the outline of the recruiting system, the price system, how to pay the charge, the contents of contracts such as basic contract and individual contract, and also the initial registration screen for recruiters to input the basic information for identifying the firm or organization of recruiter b.

The information to be inputted on the initial registration screen is as follows.

Information for identifying the recruiter:

Name of firm or organization, address, telephone number, FAX No., electronic mail address, home page URL, etc.

Information for identifying the address:

Place of work, name, post, telephone number, FAX No., electronic mail address, etc. of the person in charge of the firm or organization.

Information of the address for making a request for advertising fee:

Address for sending the bill, etc.

Information about the characteristics of the recruiter:

Type of business, amount of capital, main customers, banks, etc.

Manager's Data Base; s 2

The recruitment information collecting means 200 receiving the return screen with the information entered from the terminal equipment of recruiter b issues and transmits a recruiter ID and password to the recruiter b, and also produces basic information database 721 for the recruiter of recruiting database 720 in accordance with the information from the recruiter b (see FIG. 1). That is, the recruitment information collecting means 200 picks up necessary information out of the information of recruiter b and grants the recruiter ID to the recruiter, and stores each information in the basic information database 721 of the recruiter, and on the other hand, transmits the recruiter ID and password to the terminal equipment of recruiter b.

The contract with manager a may be regarded as being completed on the basis of the basic information transmitted from recruiter b, and in that case, the contract items are made clear on the web site and also it is to be made clear that the contract is completed on transmission of the information. In this case, it is also preferable that the input information returned from recruiter b is rearranged by the recruitment information collecting means 200 and is again returned to recruiter b for confirming the contents of the contract and the returned information before making the final return of the information. Also, in the present example, the basic information of recruiter b is first registered and specific recruitment information is individually registered, and accordingly, in the registration of basic information, only the basic contract that specifies the relation between the two sides is concluded. And, in the registration of specific recruitment information, the individual contract that relates to a credit and debt about actual money is concluded.

In the initial registration of recruiter b, it is preferred to make the registration by using an on-line system as described or an off-line as well. That is, necessary items including the contract items and registration items are entered in the application form, and the contract (basic contract) is concluded in written form between manager a and recruiter b. The off-line information is inputted by the manager using the inputting means connected to the recruitment information collecting means 200, which produces the basic information database 721 for the recruiter of recruiting data base 720. At the same time, a recruiter ID and password are issued to the recruiter b.

Registration of Specific Recruitment Information

Individual recruiting information is registered after completion of registration of recruiter's basic information.

First, recruiter b goes back to “Recruiter's page 102” and further advances to “Specific recruitment information registration page 105” linked thereto. In that case, the recruiter is requested to take procedures for certification such as delivery of the recruiter ID and password issued in the registration of basic information to the information providing server. In the “Specific recruitment information registration page 105,” a screen for inputting necessary items such as contents of recruit is transmitted from the information providing server to the terminal equipment of recruiter b, and the recruiter b makes an necessary entry and returns the information to the information providing server.

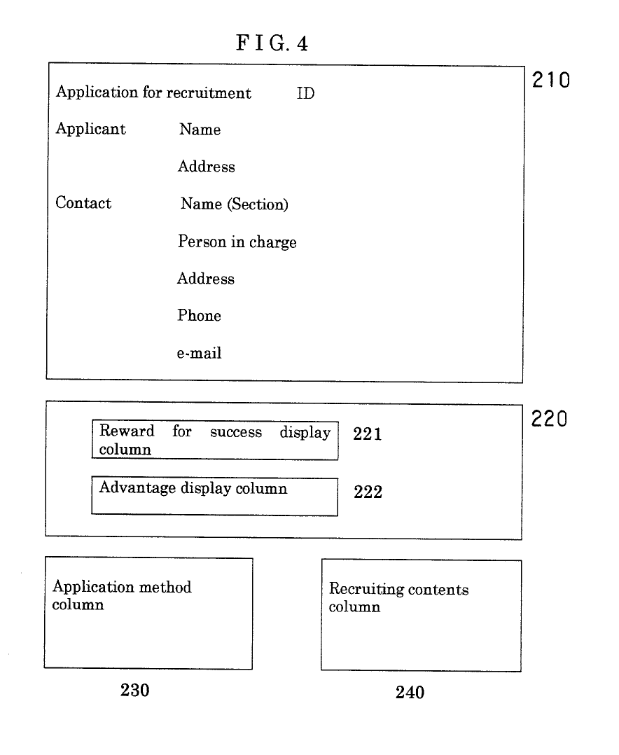

An example of input screen transmitted to recruiter b in the “Specific recruitment information registration page 105” is shown in FIG. 4.

This screen is provided with a recruiter identifying page 210, fee and advantage column 220, applying method column 230, and recruiting contents column 240.

The recruiter identifying column 210 is provided with a recruiter ID column, recruiter's basic information column, address identifying column, and recruiter's characteristics information column. As for each of these columns, the recruiter's information registered in the basic information database 721 is checked according to the recruiter ID, and the information displayed on the screen is transmitted from the information providing server to the terminal equipment of recruiter b. That is, although it is not specifically illustrated, in the “Registration of recruiter's basic information,” the information displayed including the contents of the registration already inputted is transmitted from the information providing server to the terminal equipment of recruiter b. In the case of a system in which “Registration of recruiter's basic information” and “Registration of specific recruitment information” are not individually performed, each of the above-mentioned items as described in “Registration of recruiter's basic information” is to be inputted on the screen.

A fee and advantage display column 220 comprises a reward for success display column 221 to display the existence of a reward for success system in a part of the price system for the recruiter, and an advantage display column 222 to display that an advantage such as an encouraging bonus is granted to applicant c who makes a report of decision on employment after manager a receives the reward for success from recruiter b.

The reward for success display column 221 is a column to display information about a request for payment of all or part of the advertising fee after decision on employment such as “You are requested to pay the specified reward for success (e.g. 200,000 yen per person) as the advertising fee when applicant c employed by your firm through this system is in service at your firm for a specified period (e.g. 30 days) since the initial working day.” In the present example, the continuation of a state being in service for a specified period since the initial working day is regarded as final decision on employment, but the decision on employment (e.g. when a contract for work has been concluded between recruiter b and applicant c) may also be regarded as final decision on employment. Also, it is possible to change the conditions for the time of requesting the reward for success such as the time when applicant c takes an action to recruiter b by sending a personal history or receiving an interview, or when the provision of recruitment information has brought about a specific result, other than the time of decision on employment.

Also, in addition to the reward for success, it is possible to combine it with a fixed fee such as an application fee to be paid (requested) at the time of application for advertisement. Further, it is allowed to make a change in accordance with the space of advertisement and the volume of information. In this way, when fully or partially giving an allowance for selection or decision to the applicant c with respect to the amount of reward and the conditions for request or the like, the reward for success display column 222 may be provided with an information inputting section (not shown) to input the amount of reward and the conditions for request.

Further, the reward for success display column 221 is also preferred to be displayed in the “Registration of recruiter's basic information” and to be transmitted from manager a to recruiter b by once at least before completion of “Registration of specific recruitment information.”

The advantage display column 222 is a column to display information about granting an advantage to applicant c after manager a receives the reward for success from recruiter b such as “The specified advantage (e.g. encouraging bonus of

50,000 yen) will be granted by us (manager a) to the applicant c to be employed after you (recruiter b) have paid the reward for success to us (manager a).” Preferably, the advantage may be cash, exchange ticket, articles like souvenir or any kinds of services. The amount of money and the content of the advantage may be decided by the manager a beforehand, and it is also preferable that recruiter b fully or partly makes the decision. In that case, the manager a may previously specify the minimum lowest amount of the reward for success and advantage. Also, it is allowable that the recruiter b decides the reward for success and advantage separately, and linking the reward for success to the advantage is possible as well. For example, the amount of money by a specified ratio (e.g. a quarter) as against the reward for success is set as the amount of advantage. The amount of money by a specified ratio (e.g. 3 times) as against the advantage is set as the amount of reward for success.

Thus, when it is possible for the recruiter b to decide at least either one of the amount of reward for success, the amount and content of advantage, the advantage display column 221 is to be provided with an information inputting section (not shown) to enter the amount and content decided.

Also, as described, the manager a pays the advantage for a part of the reward for success obtained by manager a as the advertisement fee if preferred, but it is also preferable that the manager a keeps the advantage for the recruiter b separately from the reward for success, and the advantage is paid from the manager a to the applicant c.

The method of application by applicant c to recruiter b is inputted in the applying method column 230. There are examples of information to be inputted such as the period of advertisement (the desired period of advertising by manager a with respect to individual recruitment information), method of application (the actions to be taken by the applicant in making an application by mailing personal history, telephone, electronic mail, receiving direct interview, etc.), period of application (the period needed for the applicant to take actions in making an application).

The contents of recruitment such as the detail of job, qualification, conditions for employment, salary, etc. are inputted in the recruiting contents column 240.

As for the detail of job, there are examples such as the kind of job, specific contents of job, period of employment (regular, part time, work by the season or the day), place of work, number of employees, etc.

As for the qualification, there are examples such as age, educational background, licenses required, experience, etc.

As for the conditions for employment, there are examples such as working hours, extra-working required or not, monthly average hours, break, holidays, monthly average workdays, annual working hours, etc.

As for the salary, there are examples such as wage system (on month, day or hour basis), wage per month (basic salary), allowance, commuting allowance to be paid (whole amount, fixed amount, highest amount), closing day for salary, payday, wage raise (result of previous year).

For how to input these data, it is desired to input the specified items in the blank of the specified format.

In the registration of recruiting information by a firm or organization, it is also preferable to input the data by classifying them into essential and optional ones or by classifying the information into the one to be opened and the one not to be opened to the third party such as the applicant. Also, the applicant, for instance, is able to select from open information and closed information if preferred.

Manager's Database

After entry of the such specific recruitment information, recruiter b transmit (return) the information to manager a. And, the recruitment information collecting means 200 receiving the return screen from the terminal equipment of the recruiter b issues and transmits a “recruitment information ID” to the recruiter b and at the same time produces specific recruitment information database 722 for the recruiter of recruiting database 720 in accordance with the information (see FIG. 1). That is, the recruitment information collecting means 200 picks up necessary information out of the returned specific recruitment information of recruiter b and registers the information in the specific recruitment information database 722.

In the registration of the specific recruitment information, the result is such that an individual contract that includes the matter of credit and debt has been concluded between the recruiter b and the manager a, and it is desired to provide a display column to meet the purpose on the screen transmitted from manager a to recruiter b in “Registration of specific recruitment information.”

In the registration of specific recruitment information, it is preferable to make the registration by an on-line system as described or by an off-line system. That is, necessary items including the above-mentioned input items are entered in the specified application form, and manager a accepts the application in written form from recruiter b. The information registered by off-line is inputted by manager a using an inputting means connected to recruitment information collecting means 200 to produce specific recruitment information database 722 of recruiting database 720. Simultaneously, a recruitment information ID is issued to recruiter b.

Recruitment Information Database Reading by Applicant;s

The recruitment information in a database, collected by the above method, is disclosed through Internet. Specifically, applicant c first contacts the terminal equipment to Internet and sends URL of an information providing server to make a connection with the web site of manager a. The applicant advances from “Applicant's page 103” to “Reading page 106” linked thereto, and is able to retrieve and read the contents of recruiting database 720 (basic information database 721 and specific recruitment information database 722) by the recruitment information disclosing means 300 of the information providing server. At that time, it is unable to read the reward for success and closed information so desired by the recruiter. Accordingly, it is also preferable to classify the recruiting database into a database to be disclosed and a database not to be disclosed.

It is possible to retrieve the contents of database in various ways, for example, by properly selecting from among the registration items mentioned above such as advantage, district, company name, capital, kind of job, and qualification.

Database retrieval and reading by the applicant c may be performed free of charge, and it is also possible to charge.

In database retrieval, the recruitment information disclosing means 300 transmits a screen for inputting the checking conditions to the terminal equipment of applicant c connected to an information providing server. The conditions such as advantage, scale of business, and type of job are inputted on the screen and are returned to the recruitment information disclosing means 300. The recruitment information disclosing means 300 retrieves relevant recruitment information from the recruiting database 720 according to the retrieval conditions and puts the recruitment information registered together with recruitment information ID on the specified output screen for reading to transmit the output to the terminal equipment of applicant c. The applicant is able to retrieve in further detail from the result of retrieval. For the result of retrieval, all the disclosed information may be outputted at one time, but it is also possible to first output a part of recruitment information whose outline has been disclosed, followed by more detailed open information if desired by the applicant.

In reading of a recruitment information database by the applicant, information about the advantage (encouraging bonus, etc.) given to the applicant at the time of decision on employment is transmitted at the same time.

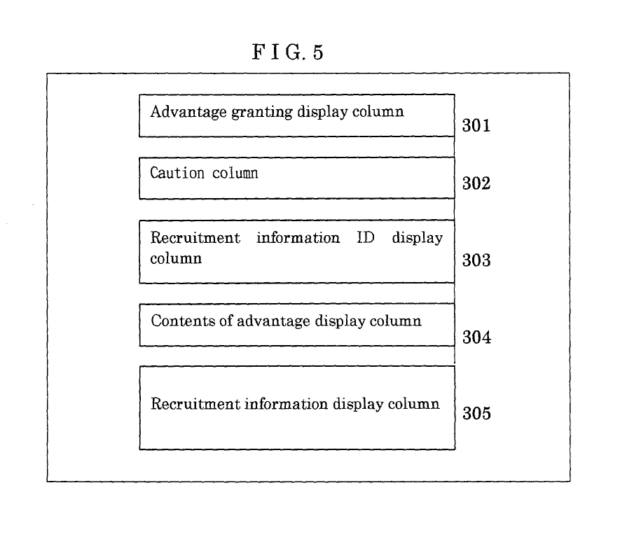

For example, the outline of the recruitment information system is displayed on the screen of “Applicant's page 103” as shown in FIG. 5, and also there is provided an advantage granting column 301 that displays a statement like “When you get employment through this system, you may receive an encouraging bonus (advantage) by making an application to us (manager a) by using the ‘Application page’ within the specified period (e.g. 30 days) since the initial day of service” notifying that an advantage is granted to the applicant who makes a report of the decision on employment to the manager. In the present example, the application is accepted through the communication means of Internet, but it is also possible to use other communication means such as telephones, mailing of documents, FAX, etc. instead of Internet or in combination with it. Also, there is provided a caution column 302 to ask you to write the recruitment information ID, which displays a statement like You are requested to write the recruitment information ID since a recruitment information ID mentioned in each recruitment information display column is necessary when making an application for the advantage.

Next, recruitment information ID display column 303, advantage contents display column 304 to display the contents of advantage (e.g. amount of bonus), and recruitment information display column 305 are provided every recruitment information on the screen of “Applicant's page 103.” Incidentally, the output screen for reading of such recruitment information may be identical with the screen of the above-mentioned advantage granting column 301 or caution column 302, but it is also possible to provide a different screen. Also, when the amount of bonus displayed in the advantage contents display column 304 differs with recruitment information, it is desirable to provide a screen for each recruitment information, but it is also possible to provide a screen for guide when an equal amount of bonus is granted for instance. When a bonus other than cash is granted, it is also possible to display the contents of advantage such as articles and services to be granted. Further, it is possible to mention only marks and symbols such as A, B, C in the advantage contents display column 304 of the recruitment information reading screen and to provide another column in the screen for guide to display specific contents of advantage.

[Recruitment; s 3]

[Application; s 4]

[Passed or Failed; s 5]

[Decision on Employment; s 7]

[Service; s 8]

Applicant c, finding a desired firm or organization by reading the recruitment information, makes an application to recruiter b in accordance with the method of application displayed in the recruitment information column 405. Specifically, the action taken by the applicant includes sending personal history, visiting the firm, receiving an interview or test, etc. In this way, the applicant is employed, resulting in the final decision on employment after lapse of the specified period (e.g. 30 days) since the initial working day.

When the applicant is unable to find a desired firm or organization at the step of Recruitment s 3 or failed at the step of Passed or failed s 5 or failed to continue the service at the step of Service s 8, it does not result in the final decision of employment, and then the applicant has to go back to the step of recruitment information reading.

[Application for Advantage by Applicants 9]

After the decision on employment, applicant c is able to make an application for advantage to manager a. The application may be made in various ways such as telephones, FAX, mailing document, etc. provided that the decision on employment can be reported to the manager a. In the present example, a method of application through Internet will be described. First, manager a accepts the application by using application treating means 400.

Applicant c first connects the terminal equipment to Internet and delivers URL of an information providing server to make a connection with the web site of manager a. The application treating means 400 of manager a sends the home page (front page screen) to the terminal equipment of applicant c. The home page is linked to “Applicant page 103,” and further the “Applicant page 103” is linked to “Application for advantage page 107.” In the “Application for advantage page 107,” the application treating means 400 sends the screen information for application for advantage (encouraging bonus) to the terminal equipment of applicant c. The page is provided with information that describes the outline of the system ranging from application for advantage to granting the advantage and also an application screen for the applicant to input the information for applicant c to make an application.

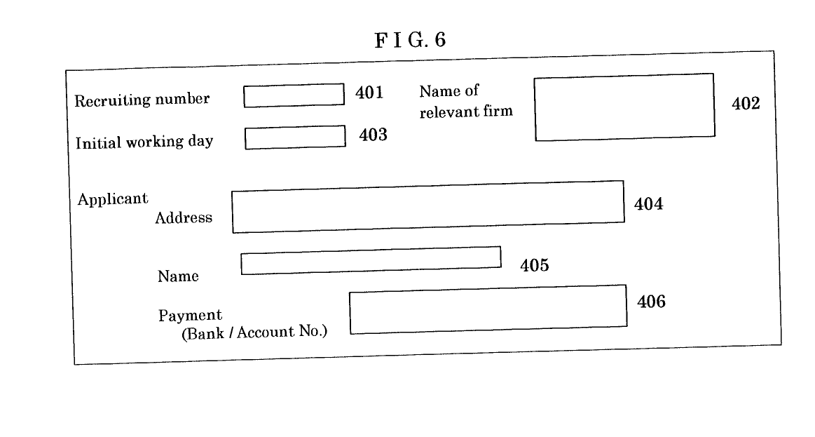

FIG. 6 is an example of the application screen where there is provided an input column (e.g. recruitment information ID input column 401 and firm or organization name input column 402) to identify the firm or organization (recruiter b) that has decided to employ the applicant and also a work starting day input column 403 in order to confirm the decision of employment. Further, as an input to identify the applicant, there is provided input columns 404, 405 to input the address and name respectively. It is also possible to provide input columns (not shown) to input the age, telephone number, FAX No., electronic mail address in addition to the address and name. Also, there is provided an input column (monetary institution, account No. input column) 406 to identify the address (for example, cash depositing address) to which the advantage is delivered.

Applicant c inputs the above information in the screen for application and transmits the information to manager a. The application treating means 400 receiving the information from the terminal equipment of applicant c stores the information from applicant c in application database 740. That is, the application treating means 400 picks up necessary information out of the application information returned from the applicant c and gives it the application ID, and then stores the information in the application database 740. It is also preferable that the application ID is transmitted to the applicant c.

When the application from the applicant c is accepted by off-line as in a written form or the like, the items necessary for the application are inputted in the application treating means 400 by manager a and stored in the application database 740. Also, an electronic mail formed in an optional style may be received from applicant c, but it is desirable to provide a specified format so that the information can be smoothly kept in the form of a database.

[Confirmations 10]

The accepted application for advantage is checked by the manager and the recruiter for the purpose of confirmation.

Confirmation by Manager

First the confirmation by manager is described in the following. The application treating means 400 checks the application information stored in application database 740 with the recruitment information stored in recruitment database 720 to confirm the existence of recruiter b, identified by the application information, in the recruitment information. For example, when the recruitment information ID is in the application information, it is checked to confirm that the name of recruiter b in the application information is identical with the name of recruiter b in the recruitment information. Also, it is checked to see that the information of initial working day satisfies the conditions for application (the date of application is within the specified period (30 days) since the initial working day). When the application information is not appropriate, the application treating means 400 will prepare an electronic mail for confirmation and transmit it to the applicant c to ask the applicant for reconfirming the application information. In this case, it is possible to manually check the application information with the recruitment information and also to check for inappropriate information to the applicant by telephone or mailing a letter or the like. It is also allowable to perform the confirmation by recruiter as described below instead of the confirmation by manager.

Confirmation by Recruiter

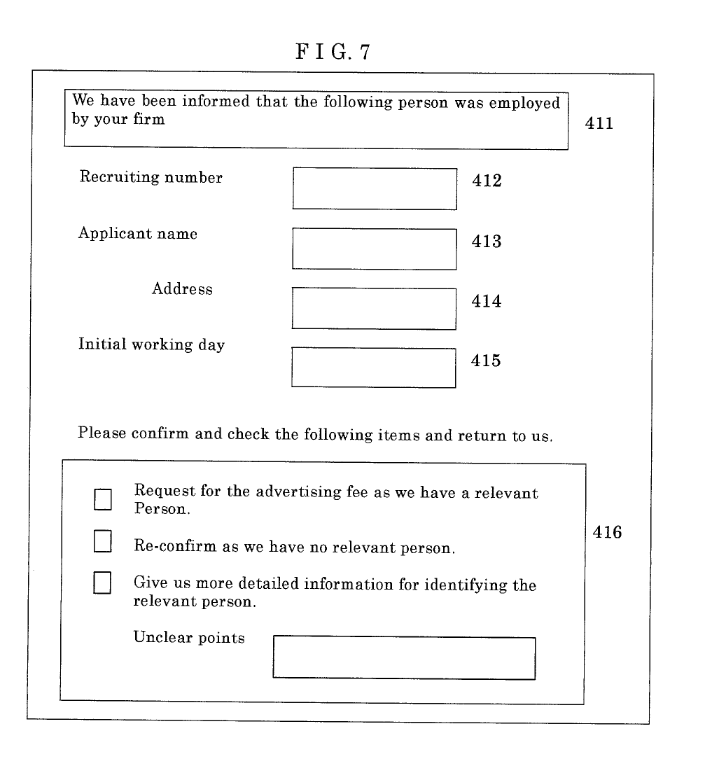

After the manger a has confirmed that the application information is appropriate, the application information is delivered to the recruiter b to receive the confirmation by recruiter b. This confirmation may also be performed by telephone, FAX or mail or the like, and it is also possible to use an electronic mail. FIG. 7 is an example of a format of electronic mail for confirmation, and there is provided a column 411 to display the desire for confirmation, recruitment information ID display column 412 to identify the recruitment information, and display columns 413, 414, respectively for the name and address of applicant c, to identify the applicant. It is also possible to display the age, telephone number, FAX No., electronic mail address, etc. in addition to the address and name. And to identify the period of employment, it is preferred to provide a display column 415 to display the initial working day, and already advertised recruitment information may also be displayed to make sure as needed.

It is also desirable to provide a confirmation answer column 416 in which a comment for confirmation is previously displayed so that the recruiter b may easily return the information.

It is preferred that the application treating means 400 picks up the contents of each display column out of the application information stored in application database 740 and the recruitment information stored in recruitment information database 720 and automatically puts the information on an electronic mail, and also the operation may be manually performed.

The recruiter b asked for making the confirmation checks to see that the identified applicant c is actually employed at the firm and then sends the answer to the manager a. In this example, the recruiter puts a check mark in the relevant portion of the confirmation answer column 416 of the electronic mail for confirmation in FIG. 7 to return the answer to the manager a. It is also possible to make the confirmation answer by telephone, FAX, mail or the like besides electronic mail.

In each of the above operations, when the employment of the applicant c is not confirmed, the manager a gets in touch with applicant c by telephone, electronic mail or the like to check the contents of the application, and asks the recruiter b to make the confirmation again. Also, the applicant c gets in touch with the recruiter b to confirm and then reports the result to manager a. When the application of applicant c is appropriate and confirmed by recruiter b, the information of the result will be stored in the application database 740. Also, when the application is accepted but there arises a problem during operation for the confirmation, or when confirmed that the application is not appropriate, the information of the progress or the result may be stored in the application database 740.

In the above description, the application by applicant c has been mainly taken up, but it is also possible that recruiter b makes an application depending upon the reliable relation between manager a and recruiter b. In that case, it is unnecessary to perform the above operations for confirmation.

More particularly, in addition to or instead of [Application for advantage by applicant s 9], it is possible to provide a means to make an application so that recruiter b may make an application to manager a for granting of an advantage. Regarding the application for an advantage by recruiter, it is possible to employ various means such as telephone, FAX, and document mailing provided that recruiter b is able to inform manager a of the decision on employment of an applicant. The method of application through Internet is briefly described here. Manager a provides a means to treat the application from a recruiter as a recruiter's application accepting means. It is possible to use the recruiter's application accepting means in combination with or in place of the above application treating means 400. That is, it is configured such that there is provided a same page as the above “Application for advantage page 107” by linking it to “Recruiter's page 102” so that the information of recruiter b and the information of applicant c to be granted an advantage may be received from the recruiter. Specifically, it is preferred to provide an input column (financial institution name, account number input column) to identify the address and name for granting of an advantage (e.g. cash depositing address) to identify the applicant c and an input column (not shown) for age, telephone number, FAX No., and electronic mail address together with an input column (e.g. the recruitment information ID input column 401 and firm or organization input column 402 or the like input column) to identify the recruiter b. Also, it is preferable to provide an initial working day input column to confirm the decision on employment. The recruiter's application treating means received from the terminal equipment of recruiter b stores each of the above information transmitted from recruiter b in the application database 740. When the application from recruiter b is received by off-line as in a written form, the information is inputted by manager a and stored in the application database 740. In the case of this application, the confirmation by recruiter is not necessary as a rule, and it is preferable to make an application by manager himself according to the same procedure as in the above [Application for advantage by applicant s 9] as needed. Also, when the application by applicant and the application by recruiter are used in combination, it is desirable to check, for instance, by retrieval of the application database 740 in order to avoid overlapping of the applications. Further, it is also preferred that manager a gets in touch with applicant c by telephone, electronic mail or the like to check for the contents of application by recruiter, thereby preventing an advantage from being granted to a wrong person.

[Request for Reward to Recruiters 11]

In each of the above operations for confirmation, when the employment of applicant c is confirmed, manager a prepares a request for reward for success and sends it to recruiter b. Manager a inputs the name of recruiter b and the specified amount of reward requested by using the requesting means 500. The operation to input the information may be manually performed by manager a or it is possible, by using requesting means 500, to pick up necessary information such as the name of the relevant recruiter b and the amount of money from the application database 740 and recruitment database 720, and to send a request bill to the recruiter.

When the request bill is delivered, an request ID is granted every request and there is formed a request database 750 in which the information (e.g. recruiter ID) to identify the address, information (e.g. applicant ID) to identify the applicant, information (application ID) to identify the application, and information about the request such as the amount of money requested and the date of request bill are stored.

[Payment of Reward from Recruiter; s 12]

[Granting of Advantage to Applicant; s 13]

When the reward has been paid from recruiter b to manager a in accordance with the request bill, the manager a executes the payment of an advantage (e.g. encouraging bonus) to the applicant c. The manager a checks the copy of the request bill and retrieve the request database 750 to identify the application in relation to the advantage granted by judging from the address and the date of the request bill already paid. The application database 740 is retrieved from the identified application to pick up the address for granting of the advantage thereby creating the information for granting of the advantage. When the contents of advantage vary with recruitment, it is necessary to pick up the contents of advantage and the amount of money out of the recruitment database 720 although it is unnecessary when the contents of advantage do not vary with recruitment.

An advantage ID is given to the information (e.g. address for granting advantage (applicant c), contents of advantage) necessary for granting of the advantage to create advantage database 760, and also, in case of cash remittance, the information is transmitted to the financial institution for the purpose of remittance.

It is also possible to automate the above processes by using advantage granting means 600.

Described above is the outline of a system in accordance with an embodiment of the present invention. It can be supposed that a recruiter and an applicant plot together to give an unreasonable amount of bonus to the applicant employed without reporting the fact to the manager. Accordingly, it is also preferred that, after the payment of the first advantage, the second advantage (encouraging bonus) is paid to the employee after lapse of a specific period (e.g. six months). Also, it is possible to adopt a method such that an additional bonus is given to the applicant, for example, granting a big prize or money to the prize winner by drawing lots.

Also, in the example of the above embodiment, an applicant sends a report of the decision on employment to a manager, but preferably such report to the manager is made by a recruiter or by either one of the both.

Further, in the example of the above embodiment, any information from an applicant is not required at the stage of reading the recruitment information, but it is also preferred to ask applicants desiring to read the recruitment information to make the initial registration in order to prepare a database of job applicants. In that case, it is possible to provide the recruitment information by electronic mail or the like to the applicants wishing to get employment. That is, it is possible to provide the information by electronic mail or the like to applicants in addition to or in place of the recruitment information database reading by applicants 3. Further, instead of asking an applicant desiring to read the recruitment information to make the initial registration, it is also possible to provide the applicant with the information by electronic mail or the like in accordance with the information of a recruiter obtained by a separate means. Also, in the example of the above embodiment, suppose that manager a is a service provider, recruiter b is a service fee payer, and applicant c is a person to be provided with the service, then the idea of the above information providing system may include a variety of applicable information providing services such as new member or student recruitment information providing services, travel information providing services, matrimonial information providing services, and real estate information providing services. Further, it is possible to provide a system such that an applicant is able to receive services free of charge and is not obliged to pay any money to a recruiter and also to provide a system such that an applicant is obliged to pay a certain amount of money to a recruiter.

As described above, a recruiting system as defined in the first invention of the present invention provides a recruitment information providing system wherein a recruiter providing recruitment information may pay more reasonable expenditure for provision of recruitment information by fully or partly employing a reward payment system (reward for success system) according to the actual result such as decision on employment, and a manager may obtain the reward more precisely even when the reward for success system is fully or partly introduced, and an applicant may receive an advantage such as an encouraging bonus by satisfying specific conditions such as decision on employment. Accordingly, the first embodiment of the present invention is able to provide a recruitment information providing system which is advantageous to all the three of a recruiter, a manager and an applicant.

The second invention of the present invention is able to provide a recruitment information providing system which is advantageous to all the three of a manager, a person who recruits or a recruiter, and a person who seeks a job or an applicant.

Also, the third invention of the present invention is able to provide a recruiting method which is advantageous to all the three of a recruiter, a manger and an applicant.

What is claimed is:

1. A recruiting system comprising:
a recruitment information providing means to provide recruitment information to a number of persons;
a means to receive a report about a specific relation settled between an applicant who came in contact with the recruitment information and a recruiter from at least either one of the applicant and the recruiter;
a means to produce information to make a request for payment of an information providing fee to the recruiter in accordance with the information received from at least either one of the applicant and the recruiter; and
a means to produce information to give an advantage to the relevant applicant in accordance with the information received from at least either one of the applicant and the recruiter.

2. A recruiting system comprising:
a recruitment information providing means to provide recruitment information about employment and information about an encouraging bonus given to the applicant at the time of decision on employment through a computer network;
a means to receive a report about recruiter's decision on employment of the applicant who came in contact with recruitment information provided by the information providing means from at least either one of the applicant whose employment has been decided and the recruiter;
a means to memorize the received information about the decision on employment;
a means to produce information to make a request for payment of an information providing fee to the recruiter in accordance with the memorized information about the decision on employment; and
a means to produce information to give an advantage at the time of decision on employment to the person who delivered the report of employment in accordance with the memorized information about the decision on employment.

3. A recruiting method comprising:
a step to collect recruitment information by informing about an application for reward at a stage when a specific relation has been settled between an applicant who came in contact with the recruitment information and a recruiter;
a step to receive a report about a specific relation settled between the applicant who came in contact with the recruitment information and the recruiter from at least either one of the applicant and the recruiter;
a step to make a request for reward to the recruiter in accordance with the information received from at least either one of the applicant and the recruiter; and
a step to give an advantage to the relevant applicant after receiving said reward, in a recruitment information providing method to provide recruitment information through a computer network.
